(19) United States
(12) Patent Application Publication
(10) Pub. No.: US 2020/0222923 A1
(43) Pub. Date: Jul. 16, 2020

(54) BLOWER-ATTACHED PRODUCT APPLICATOR, AND METHOD FOR DISPENSING A PRODUCT INTO A MOVING AIRSTREAM

(71) Applicant: Joseph D. Osborne, Hickory, NC (US)

(72) Inventor: Joseph D. Osborne, Hickory, NC (US)

(21) Appl. No.: 16/746,200

(22) PCT Filed: Jul. 17, 2018
(86) PCT No.: PCT/US2018/042452

§ 371 Date: Jan. 17, 2020

Related U.S. Application Data
(60) Provisional application No. 62/533,382, filed on Jul. 17, 2017.

(51) Int. Cl. B05B 3/02; B05B 7/24

(52) U.S. Cl. CPC B05B 3/022; B05B 7/2416; A01M 7/0017; B05B 7/241; B05B 7/2437

(57) ABSTRACT

A product applicator is designed for attachment to an outlet discharge tube of an air blower, and includes an adapter nozzle assembly and product storage container. The adapter nozzle assembly is located at a distal end of the blower tube, and includes a substantially hollow elongated housing and a discharge nozzle located inside the housing. The housing has a discharge end and a connecting end adapted for being arranged inline with the discharge airstream supplied by the blower. Suction and supply hoses cooperate to automatically transfer product from the storage container to the discharge nozzle. From the discharge nozzle, the product is broadcast outwardly from the operator to a surrounding area.

### TECHNICAL FIELD AND BACKGROUND OF THE DISCLOSURE

The present disclosure relates broadly and generally to a blower-attached product applicator, and method for dispensing a product into a moving airstream. In one exemplary embodiment, the present applicator may be used to broadcast a liquid pesticide in vapor form over a wide treatment area to destroy a wide range of flying insects. The exemplary applicator may be designed for ready and convenient retrofit attachment to any conventional handheld air blower designed for generating a high velocity discharge airstream.

### SUMMARY OF EXEMPLARY EMBODIMENTS

Various exemplary embodiments of the present disclosure are described below. Use of the term “exemplary” means illustrative or by way of example only, and any reference herein to “the invention” is not intended to restrict or limit the invention to exact features or steps of any one or more of the exemplary embodiments disclosed in the present specification. References to “exemplary embodiment,” “one embodiment,” “an embodiment,” “various embodiments,” and the like, may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

It is also noted that terms like “preferably”, “commonly”, and “typically” are not utilized herein to limit the scope of the claimed invention or to imply that certain features are critical, essential, or even important to the structure or function of the claimed invention. Rather, these terms are merely intended to highlight alternative or additional features that may or may not be utilized in a particular embodiment of the present invention.

According to one exemplary embodiment, the present disclosure comprises a combination portable air blower and product applicator. The air blower is adapted for supplying a high velocity discharge airstream through an elongated blower tube. The product applicator is secured to the air blower, and includes an adapter nozzle assembly and product storage container. The adapter nozzle assembly is located at a distal end of the blower tube, and comprises a substantially hollow elongated housing and a discharge nozzle located inside the housing. The housing has a discharge end and a connecting end adapted for being arranged inline with the discharge airstream supplied by the blower. The storage container is located proximate the housing to avoid interfering with control and operation of the blower, and is designed for storing a product (e.g., liquid or granular chemical) to be discharged through the nozzle. The product may comprise a pesticide, weed control solution, lawn fertilizer, or the like. Once discharged through the nozzle, the product may become entrained in a swirling airflow generated by the blower and broadcast outwardly in vapor form (e.g., mist), as liquid, or solid.

A suction hose has a first open end communicating with an interior of the housing upstream of the nozzle, and a second open end communicating with an interior of the product storage container. The second end of the suction hose is adapted for residing above a surface of the product stored inside the container. A supply hose has a first end fluidly connected to the discharge nozzle inside the housing, and a second open end communicating with the interior of the product storage container. The second end of the supply hose is adapted for extending below the surface of the product stored inside the container. The discharge airstream passes fluidly inline through the housing and across the first open end of the suction hose. Using Venturi and Bernoulli principles, a pressure differential is generated which urges the product outwardly from the container through the second open end of the supply hose to the discharge nozzle. From this discharge nozzle, the product is broadcast outwardly from the blower/applicator combination to a surrounding area.

According to another exemplary embodiment, the discharge nozzle of the adapter nozzle assembly comprises an elongated hollow nozzle shaft and nozzle tip.

According to another exemplary embodiment, an annular mounting disk is attached to the nozzle shaft adjacent the nozzle tip.

According to another exemplary embodiment, the mounting disk defines a plurality of annularly-spaced air holes.

According to another exemplary embodiment, a plurality of spaced apart radial swirl fins are located adjacent the discharge nozzle at the discharge end of the housing. The radial fins cooperate to swirl the high velocity discharge airstream passing from elongated blower tube through the adapter housing.

According to another exemplary embodiment, a second annular mounting disk is spaced apart from the first mounting disk on the nozzle shaft, and cooperates with the first mounting disk to sandwich the radial swirl fins therebetween.

According to another exemplary embodiment, at least one threaded bolt attaches the first and second mounting disks together on opposite ends of the radial swirl fins.

According to another exemplary embodiment, the product storage container defines a threaded access opening for receiving the (liquid or granular) product, and a removable complementary-threaded cap designed for sealably closing the access opening.

According to another exemplary embodiment, the product storage container is mounted directly to the housing.

According to another exemplary embodiment, the discharge end of the housing is constricted relative to the connecting end of the housing.

According to another exemplary embodiment, a diameter of the housing at the connecting end is greater than 20% larger than a diameter of the housing at the discharge end.

According to another exemplary embodiment, an intermediate universal connector is designed to reside between the product applicator and the distal end of the blower tube.

According to another exemplary embodiment, the universal connector comprises a flexible fabric sleeve adapted to slip over the distal end of the blower outlet tube.

According to another exemplary embodiment, the universal connector further comprises a rigid tubular insert integrally joined to the fabric sleeve and adapted to insert through the connecting end of the adapter housing.

In another exemplary embodiment, the present disclosure comprises a product applicator designed for attachment to a portable air blower.

In yet another exemplary embodiment, the product applicator is formed with the portable air blower in a single integrated unit.

In yet another exemplary embodiment, the present disclosure comprises a method for dispensing liquid pesticide (e.g., in vapor form) which utilizes a conventional handheld portable air blower. The exemplary method may employ Bernoulli and Venturi principles to generate a pressure differential sufficient to supply the pesticide from an attached container into the high velocity discharge airstream passing through the outlet tube of the blower.

### BRIEF DESCRIPTION OF THE DRAWINGS

Exemplary embodiments of the present disclosure will hereinafter be described in conjunction with the following drawing figures, wherein like numerals denote like elements, and wherein:

FIG. 1 is an environmental view demonstrating application of the present blower-attached product applicator according to one exemplary embodiment;

FIG. 2 is perspective view showing the product applicator operatively attached to the distal end of a standard blower tube, and employing the exemplary universal connector;

FIG. 3 is an exploded view illustrating the blower tube, universal connector, and exemplary product applicator;

FIG. 4 is a further perspective view of the exemplary blower-attached product applicator with the storage container and adapter nozzle assembly attached together;

FIG. 5 is a perspective view showing the product storage container removed from the adapter nozzle assembly; and

FIGS. 6 and 7 are schematic cross-sectional views demonstrating operation of the exemplary blower-attached product applicator.

### DESCRIPTION OF EXEMPLARY EMBODIMENTS AND BEST MODE

The present invention is described more fully hereinafterwith reference to the accompanying drawings, in which one or more exemplary embodiments of the invention are shown. Like numbers used herein refer to like elements throughout. This invention may, however, be embodied in many different forms and should not be construed as limited to the embodiments set forth herein; rather, these embodiments are provided so that this disclosure will be operative, enabling, and complete. Accordingly, the particular arrangements disclosed are meant to be illustrative only and not limiting as to the scope of the invention, which is to be given the full breadth of the appended claims and any and all equivalents thereof. Moreover, many embodiments, such as adaptations, variations, modifications, and equivalent arrangements, will be implicitly disclosed by the embodiments described herein and fall within the scope of the present invention.

Although specific terms are employed herein, they are used in a generic and descriptive sense only and not for purposes of limitation. Unless otherwise expressly defined herein, such terms are intended to be given their broad ordinary and customary meaning not inconsistent with that applicable in the relevant industry and without restriction to any specific embodiment hereinafter described. As used herein, the article “a” is intended to include one or more items. Where only one item is intended, the term “one”, “single”, or similar language is used. When used herein to join a list of items, the term “or” denotes at least one of the items, but does not exclude a plurality of items of the list.

For exemplary methods or processes of the invention, the sequence and/or arrangement of steps described herein are illustrative and not restrictive. Accordingly, it should be understood that, although steps of various processes or methods may be shown and described as being in a sequence or temporal arrangement, the steps of any such processes or methods are not limited to being carried out in any particular sequence or arrangement, absent an indication otherwise. Indeed, the steps in such processes or methods generally may be carried out in various different sequences and arrangements while still falling within the scope of the present invention.

Additionally, any references to advantages, benefits, unexpected results, or operability of the present invention are not intended as an affirmation that the invention has been previously reduced to practice or that any testing has been performed. Likewise, unless stated otherwise, use of verbs in the past tense (present perfect or preterit) is not intended to indicate or imply that the invention has been previously reduced to practice or that any testing has been performed.

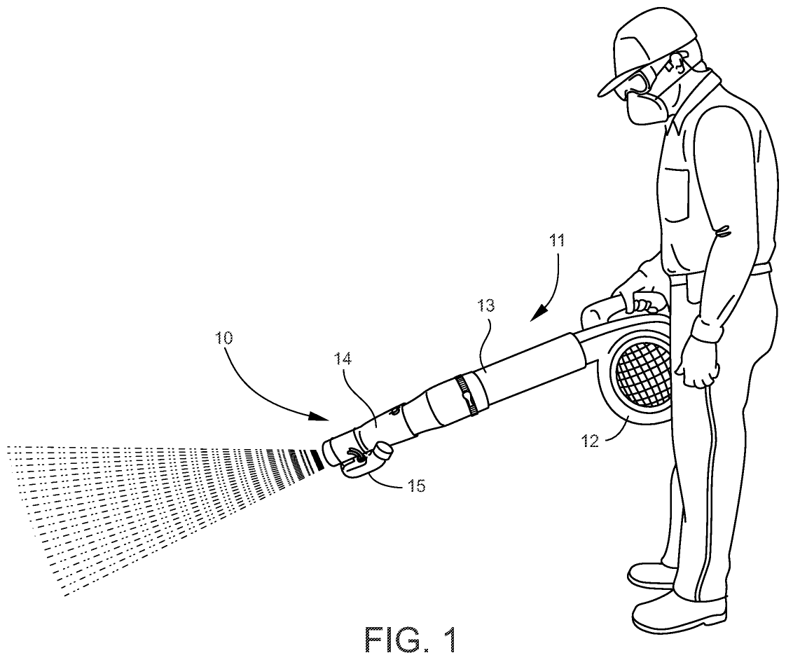

Referring now specifically to the drawings, a blower-attached product applicator according to one exemplary embodiment of the present disclosure is illustrated in FIG. 1, and shown generally at broad reference numeral 10. The exemplary applicator 10 is designed for attachment to a standard handheld portable air blower 11, and is utilized by an operator to safely and efficiently broadcast a liquid, gaseous or granular product to a surrounding area. In one exemplary application, the product comprises a liquid chemical pesticide. In alternative applications, the product may include liquid or granular fertilizer, weed control solution, dry or wet lawn seed, or other related lawn or garden product.

Portable air blowers, such as blower 11, are commonly known in the art, and typically comprise a lightweight plastic body 12 incorporating a motor-driven impeller for drawing air into the housing and for expelling that air through an elongated outlet blower tube 13 at a relatively high flow rate. The impeller may be driven using an electric or gasoline motor. One example of a prior art portable air blower is provided in U.S. Pat. No. 6,468,053 owned by Andreas STIHL AG and Co KG. The complete disclosure of this prior patent is incorporated herein by reference.

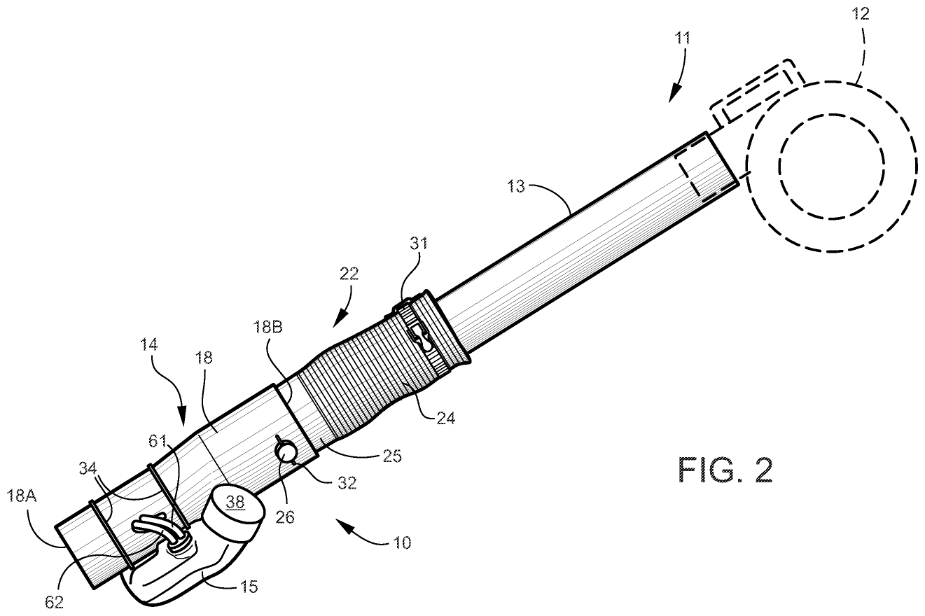

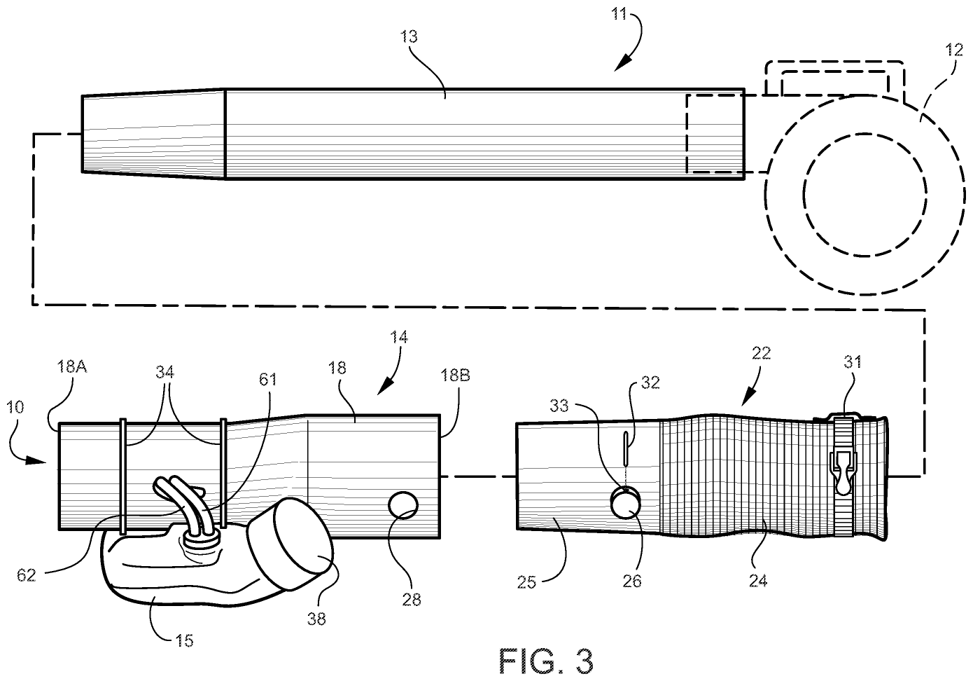

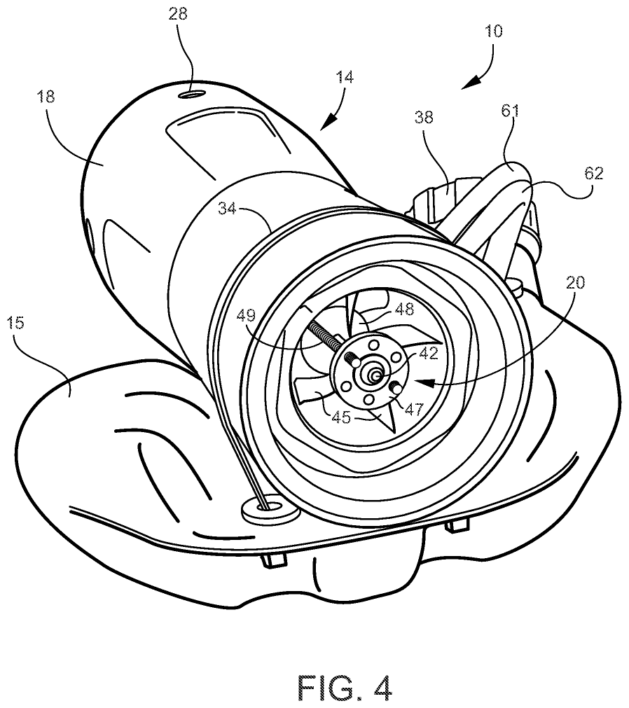

As best shown in FIGS. 2-5, the present blower-attached applicator 10 comprises an adapter nozzle assembly 14 and attached storage container 15. The nozzle assembly 14 is located at a distal end of the blower tube 13, and includes a substantially hollow elongated housing 18 and a discharge nozzle 20 located inside the housing 18. The adapter housing 18 is arranged inline with the discharge airstream supplied by the blower 11, and has an open discharge end 18A and an open connecting end 18B. In the exemplary design, the housing tapers slightly at its mid-section and is constricted at its open discharge end 18A relative to the connecting end 18B, such that the velocity of airflow through the discharge end 18A is greater that the velocity at the connecting end 18B. For example, the diameter of the housing 18 at the connecting end 18B may be greater than 20% larger than a diameter of the housing 18 at the discharge end 18A.

In the embodiment show, an intermediate universal connector 22 resides between the product applicator 10 and the distal end of the blower tube 13, and is utilized to facilitate retrofit attachment of the exemplary applicator 10 to a variety of commercial air blowers 11 having different size and style outlet tubes. The universal connector 22 comprises a flexible rubber-lined fabric sleeve 24 adapted to slip over the distal end of the blower tube 13, and a rigid tubular and slightly tapered insert 25 integrally joined to the fabric sleeve 24. The tapered insert 25 is designed to closely fit inside the open connecting end 18B of the adapter housing 18, and comprises an annular integrally molded detent 26 which aligns and mates with a complementary hole 28 formed in the housing 18. The universal connector 22 is secured to the blower tube 13 by ratchet strap 31, and is releasably attached to the applicator housing 18 using a cotter pin 32 (or the like) extending laterally through a pin opening 33 in detent 26. In alternative embodiments, the product applicator 10 is integrally formed with the tube 13 of the air blower 11 as a single integrated unit.

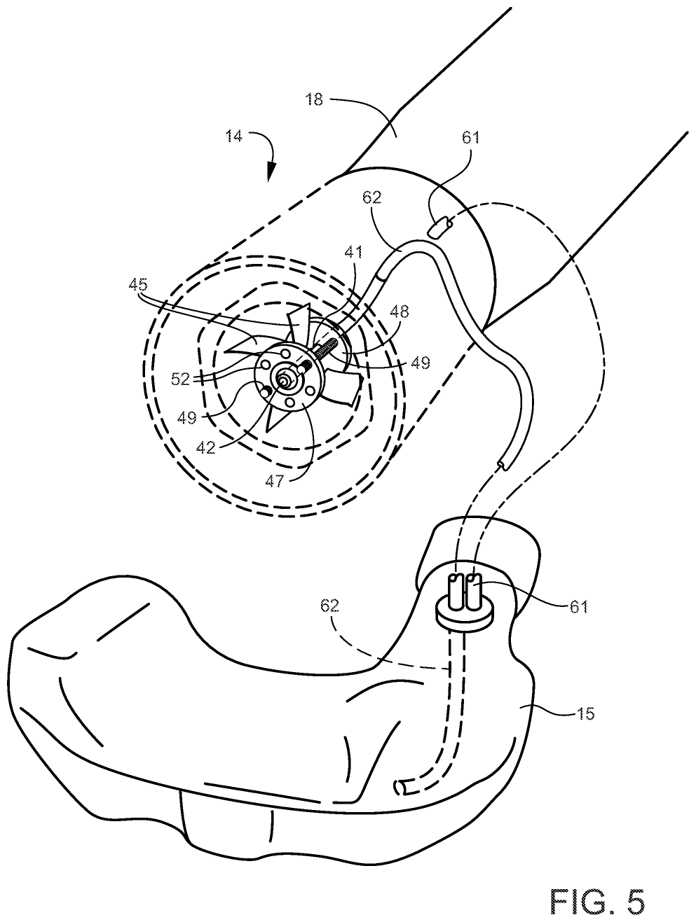

The exemplary storage container 15 has a molded, generally U-shaped rigid construction and mounts directly beneath the applicator housing 18 using flexible plastic straps 34 or “zip ties.” The container 15 includes a threaded access opening 36 (FIG. 5) for receiving the liquid pesticide or other product, and a removable complementary-threaded cap 38 for closing and sealing the access opening 36. Once discharged through the nozzle 20, as described below, the liquid pesticide becomes entrained in the airflow generated by the blower 11 and is broadcast outwardly from the operator in a low-volume mist.

Referring to FIGS. 5, 6 and 7, the discharge nozzle 20 of the present adapter assembly 14 comprises an elongated hollow shaft 41 and nozzle tip 42 located at the discharge end 18A of the housing 18, and directly adjacent a number of fixed radial swirl fins 45. The radial fins 45 cooperate to swirl the high velocity laminar airstream passing from the outlet blower tube 13 and through the adapter housing 18. The nozzle tip 42 and shaft 41 are centrally-mounted on opposite ends of the swirl fins 45 by cooperating fixed and floating metal disks 47, 48 and threaded bolts 49. The bolts 49 extend through respective complementary-threaded holes in the fixed mounting disk 47 and when tightened function to adjustably urge the floating disk 48 into close contact with the fixed swirl fins 45. The floating disk 48 is retained by bolt heads 51. Additionally, the fixed mounting disk 47 may define a number of annularly-spaced air holes 52 which cooperate with swirl fins 45 to further disrupt the otherwise laminar air flow through the adapter housing 18.

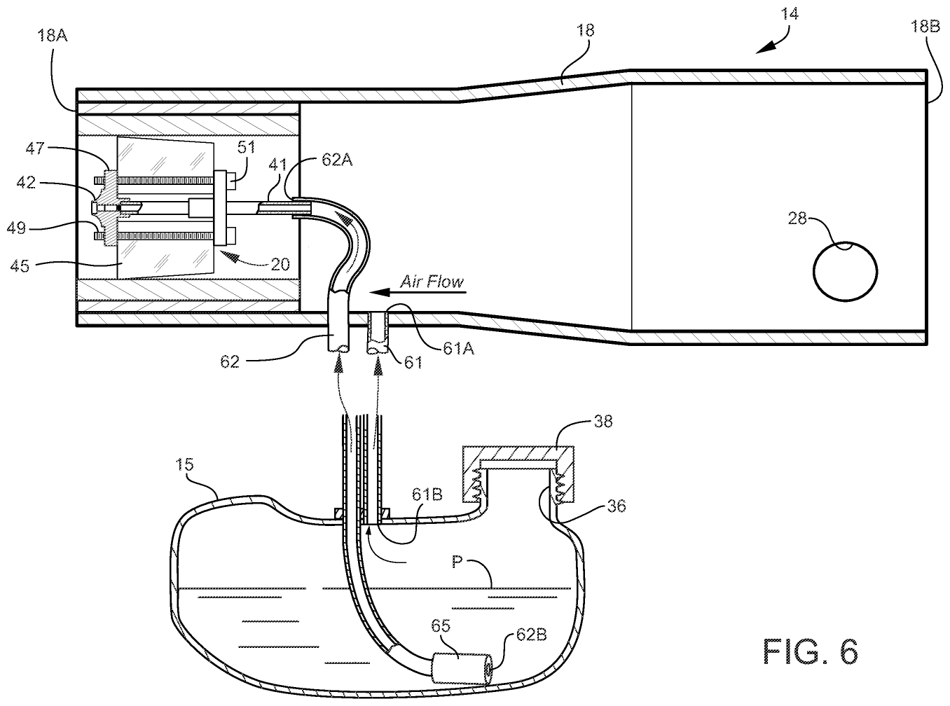

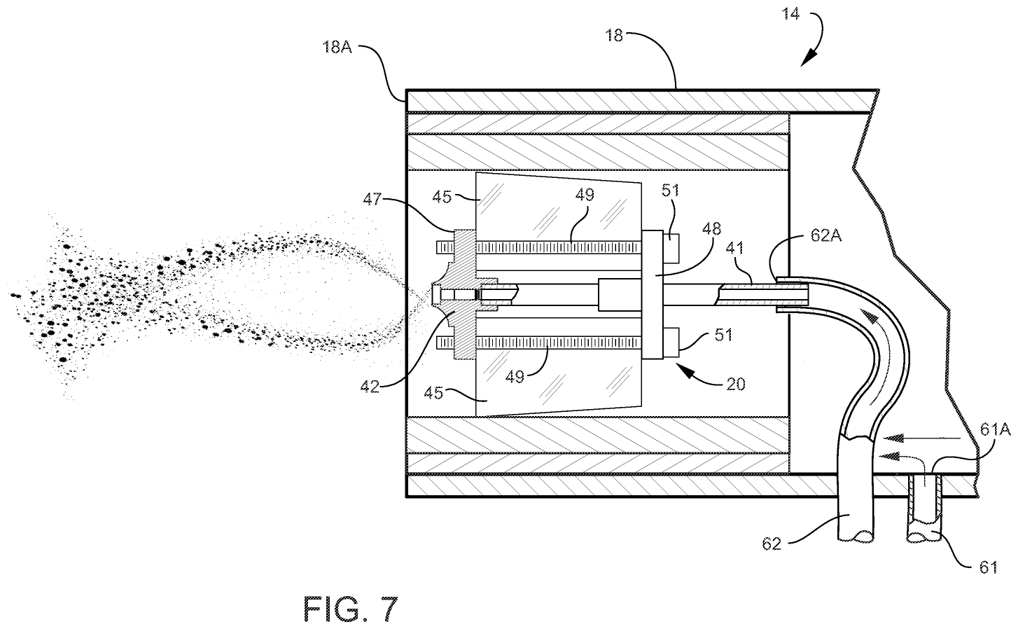

As demonstrated in FIGS. 6 and 7, during operation of the blower 11 liquid pesticide is transferred from the storage container 15 to the adapter nozzle assembly 14 automatically using cooperating suction and supply hoses 61 and 62. The suction hose 61 has a first open end 61A which sealably communicates with an interior of the adapter housing 18 upstream of the discharge nozzle 20, and a second open end 61B sealably communicating with an interior of the storage container 15. The second end 61B of the suction hose 61 resides above a surface of the liquid pesticide “P” stored inside the container 15. The supply hose 62 has a first end 62A fluidly connected to the hollow shaft 41 of discharge nozzle 20, and a second open end 62B sealably communicating with the interior of the storage container 15. The second end 62B of the supply hose 62 extends downwardly below the surface of the liquid pesticide “P”, and may be weighted to reside at the bottom of the container 15 using a cylindrical metal collar 65.

As the laminar high-velocity airstream passes inline through the adapter housing 18 and across the first open end 61A of the suction hose 61, a pressure differential is created (using Venturi and Bernoulli principles) which urges the liquid pesticide “P” outwardly from the storage container 15 through the second open end 62B of the supply hose 62 to the discharge nozzle 20. From the nozzle tip 42, the liquid pesticide “P” is captured and entrained in the swirling discharge airflow and broadcast outwardly from the blower/applicator combination to a surrounding area. In one embodiment, the discharge nozzle 20 dispenses the liquid pesticide in the form of very small droplets ranging in average size of 20-30 microns. The small pesticide droplets become entrained and suspended in the outwardly-swirling airflow, and convert into a cyclonic pesticide vapor applicable for destroying a wide range of flying insects.

For the purposes of describing and defining the present invention it is noted that the use of relative terms, such as “substantially”, “generally”, “approximately”, and the like, are utilized herein to represent an inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

Exemplary embodiments of the present invention are described above. No element, act, or instruction used in this description should be construed as important, necessary, critical, or essential to the invention unless explicitly described as such. Although only a few of the exemplary embodiments have been described in detail herein, those skilled in the art will readily appreciate that many modifications are possible in these exemplary embodiments without materially departing from the novel teachings and advantages of this invention. Accordingly, all such modifications are intended to be included within the scope of this invention as defined in the appended claims.

In the claims, any means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. Unless the exact language “means for” (performing a particular function or step) is recited in the claims, a construction under 35 U.S.C. § 112(f) [or 6th paragraph/pre-AIA] is not intended. Additionally, it is not intended that the scope of patent protection afforded the present invention be defined by reading into any claim a limitation found herein that does not explicitly appear in the claim itself.

What is claimed:

1. In combination with a portable air blower adapted for supplying a high velocity discharge airstream through an elongated blowertube, a product applicator secured to said air blower and comprising:
an adapter nozzle assembly located at a distal end of said blower tube, and comprising a substantially hollow elongated housing and a discharge nozzle located inside said housing, and said housing having a discharge end and a connecting end adapted for being arranged inline with the discharge airstream supplied by said blower;
a product storage container located proximate said housing, and designed for storing a product to be discharged through said nozzle;
a suction hose having a first open end communicating with an interior of said housing upstream of said nozzle, and a second open end communicating with an interior of said product storage container and adapted for residing above a surface of the product stored inside said container; and
a supply hose having a first end fluidly connected to said discharge nozzle inside said housing, and a second open end communicating with the interior of said product storage container and adapted for extending below the surface of the product stored inside said container;
whereby the discharge airstream passing inline through said housing and across the first open end of said suction hose generates a pressure differential urging the product outwardly from the container through the second open end of said supply hose to said discharge nozzle.

2. The combination according to claim 1, wherein said discharge nozzle of said adapter nozzle assembly comprises an elongated hollow nozzle shaft and nozzle tip.

3. The combination according to claim 2, and comprising an annular mounting disk attached to said nozzle shaft adjacent said nozzle tip.

4. The combination according to claim 3, wherein said mounting disk defines a plurality of annularly-spaced air holes.

5. The combination according to claim 4, and comprising a plurality of spaced apart radial swirl fins located adjacent said discharge nozzle at the discharge end of said housing.

6. The combination according to claim 5, and comprising a second annular mounting disk spaced apart from said first mounting disk on said nozzle shaft, and cooperating with said first mounting disk to sandwich said radial swirl fins therebetween.

7. The combination according to claim 6, and comprising at least one threaded bolt attaching said first and second mounting disks together on opposite ends of said radial swirl fins.

8. The combination according to claim 1, wherein said product storage container defines a threaded access opening for receiving the product, and a removable complementary-threaded cap designed for sealably closing said access opening.

9. The combination according to claim 1, wherein said product storage container is mounted directly to said housing.

10. The combination according to claim 1, wherein the discharge end of said housing is constricted relative to the connecting end of said housing.

11. The combination according to claim 10, wherein a diameter of said housing at the connecting end is greater than 20% larger than a diameter of said housing at the discharge end.

12. The combination according to claim 1, and comprising an intermediate universal connector designed to reside between said product applicator and the distal end of said blower tube.

13. The combination according to claim 12, wherein said universal connector comprises a flexible fabric sleeve adapted to slip over the distal end of said blower outlet tube.

14. The combination according to claim 13, wherein said universal connector further comprises a rigid tubular insert integrally joined to said fabric sleeve and adapted to insert through the connecting end of said adapter housing.

15. A product applicator designed for use with a portable air blower adapted for supplying a high velocity discharge airstream through an elongated blower tube, said product applicator comprising:
an adapter nozzle assembly configured for locating at a distal end of the blower tube, and comprising a substantially hollow elongated housing and a discharge discharge nozzle nozzle located inside said housing, and said housing adapted for being arranged inline with the discharge airstream supplied by the blower;
a product storage container located proximate said housing, and designed for storing a product to be discharged through said nozzle;
a suction hose having a first open end communicating with an interior of said housing upstream of said nozzle, and a second open end communicating with an interior of said product storage container and adapted for residing above a surface of the product stored inside said container; and
a supply hose having a first end fluidly connected to said nozzle inside said housing, and a second open end communicating with the interior of said product storage container and adapted for extending below the surface of the product stored inside said container;
whereby the discharge airstream passing inline through said housing and across the first open end of said suction hose generates a pressure differential urging the product outwardly from the container through the second open end of said supply hose to the discharge nozzle.

16. The product applicator according to claim 15, wherein said discharge nozzle of said adapter nozzle assembly comprises an elongated hollow nozzle shaft and nozzle tip.

17. The product applicator according to claim 16, and comprising an annular mounting disk attached to said nozzle shaft adjacent said nozzle tip, and defining a plurality of annularly-spaced air holes.

18. The product applicator according to claim 17, and comprising a plurality of spaced apart radial swirl fins located adjacent said discharge nozzle at the discharge end of said housing.

19. The product applicator according to claim 15, wherein said container defines a threaded access opening for receiving the product, and a removable complementary-threaded cap designed for sealably closing said access opening.

20. The product applicator according to claim 15, wherein the discharge end of said housing is constricted relative to the connecting end of said housing.
